(19) United States
(12) Patent Application Publication
(10) Pub. No.: US 2011/0024369 A1
(43) Pub. Date: Feb. 3, 2011

(54) DEVICE FOR CLEANING A FLUID BY MEANS OF A FILTER BED AND METHOD FOR DETERMINING THE EXTENT OF MOVEMENT OF THE FILTER BED

(75) Inventor: Sipco Christiaan Reekers, Sloten (NL)

Correspondence Address: FLIESLER MEYER LLP, 650 CALIFORNIA STREET, 14TH FLOOR, SAN FRANCISCO, CA, 94108, US

(73) Assignee: PAQUES B.V., Balk (NL)

(21) Appl. No.: 12/812,020

(22) PCT Filed: Jan. 7, 2009
(86) PCT No.: PCT/NL09/50001

§ 371 Date: Aug. 31, 2010

(30) Foreign Application Priority Data
Jan. 8, 2008 (NL) 2001166

(51) Int. Cl. B01D 24/28; B01D 24/48

(52) U.S. Cl. 210/786; 210/91

(57) ABSTRACT

The present invention relates to a device for cleaning a fluid, wherein the device comprises a vessel, a filter bed with granular filter material, such as sand, wherein the filter bed is provided in the vessel; a transport system arranged to agitate filter material of the filter bed during operation; and a sensor system. The sensor system comprises a contact body that comes in contact with the filter material in the filter bed; and a vibration sensor connected to the contact body for sensing vibrations of said contact body. The vibration sensor is arranged for producing a signal which is dependent on the vibrations detected by the sensor. The contact body comprises the wall of the vessel and/or a rod extending into the filter bed. The invention relates further to a method for determining the degree of movement of a filter bed with granular filter material, wherein a contact body is used which comes into contact with the filter material in the filter bed, and wherein the degree of movement of the filter material is determined by sensing the vibrations caused by the movement of the granular filter material of said contact body.

The present invention relates to a device for cleaning a fluid, wherein the device comprises:

a vessel;

a filter bed with granular filter material, such as sand, wherein the filter bed is provided within the vessel;

a transport system arranged to cause movement of filter material of the filter bed during operation;

a sensor system.

A device such as a sand bed filter reactor for cleaning a fluid is widely known. The fluid to be cleaned, the influent, is caused to pass through the sand bed and the filter material is put into motion by means of a transport system. The movement of the filter material is often based upon the recirculation of the filter material through the bed, for example, by feeding filter material from the bottom of the bed to the top of the bed where it is deposited, either before or after treatment of the filter material, after which it drops downwards as it continually moves from the bottom to the top of the bed. Such devices are also used for cleaning industrial and domestic wastewater. In a device as such, it is not unknown for a sensor system to be used for measuring certain physical quantities, such as the temperature or composition of the fluid in the device.

In such equipment, it is important that the cleaning operation is monitored and adjusted if necessary, and in particular it is regularly desirable to ensure that the cleaning operation remains constant. In this connection, it is also known that it is important that movement of the filter bed remains constant. It may occur, however, that the speed of movement of the filter material in the vessel suddenly deviates, and that this is not readily observed by the operator. It is known in the prior art to monitor the movement of the filter bed regular monitoring by inserting a vertical measuring stick and by observing how quickly the measuring stick descends to the bottom in the moving filter bed.

FR 2 373 319 describes a vessel in which a granular filter material is fixed at a certain position. Fluid is caused to pass through the filter material. A vibration unit is mounted on the vessel. As fluid is filtered in the vessel, a predetermined vibration is transferred to the fluid. The predetermined vibration (frequency, amplitude, dimension) is adapted to the filter material. The vibrating filtration results in an improvement. The filter material is also cleaned as it vibrates. A sensor is not present. The vibration generated is not measured. U.S. Pat. No. 5,308,479 also describes a device with filter bed, wherein in a vibration unit supports filtering.

A sander is known from RU 2283788. The amount of sand in the sander is checked. An ultrasonic vibration sensor is secured on the sand box wall. A hopper is known from JP 2006-047096. The hopper has a vibration sensor which is designed to discriminate aggregates such as ballast or sand.

The object of the present invention is to provide a device according to the preamble of claim 1, wherein it is possible to continuously monitor the movement of the filter bed, in particular the speed of movement of the filter bed. This allows the operator to intervene very quickly if a movement of the filter bed changes, or otherwise deviates from the intended movement.

The aforementioned object, according to the invention, is achieved by providing a device for cleaning a fluid, wherein the device comprises:

a vessel;
a filter bed with granular filter material, such as sand, wherein the filter bed is provided within the vessel;
a transport system arranged to cause movement of filter material of the filter bed during operation;
a sensor system;
characterized in that
the sensor system comprises:
a contact body that comes in contact with the filter material in the filter bed;
a vibration sensor connected to the contact body for sensing vibrations of said contact body;
wherein the vibration sensor is arranged for producing a signal which is dependent on the vibrations detected by the sensor.

The invention is based upon the principle that if a contact body is connected with the filter bed in such a manner that this body comes into physical contact with the moving parts of the granular filter material that vibrations are generated, primarily acoustic sound waves, by the movement of granular filter material along the contact body. These vibrations are detectable by means of a vibration sensor connected to the contact body. In order to inform the operator or an automated control system, the vibration sensor is arranged so that it produces a signal that depends on the vibration sensed by the sensor. When the motion of the filter bed changes, the sensor will detect other vibrations and change the signal produced by the sensor. Accordingly, in principle, it is possible to relate the vibrations detected by the sensor to the degree of movement of the filter bed.

Although the measurement of a vibration is generally known, the measurement of vibrations generated by filter material is not widely known and, based upon the prior art, it is therefore not presumed that the vibration can be measured, let alone be used for determining the movements of the filter bed.

The contact body as such may be formed in different ways.

According to a particular embodiment, the contact body comprises the wall of the vessel. The vibration sensor is mounted onto the wall of the vessel, more specifically on the outer side of the vessel and measures the vibration within the wall of the vessel. Because the wall of the vessel covers the entire filter bed, as it were, an average value for the entire filter bed is sensed.

According to another embodiment, the contact body comprises a rod inserted into the filtering bed. The movement of the granular filter material can be measured at the location of measuring rod. Accordingly, measurements can be made locally in the filter bed. If necessary, several of these rod-shaped contact bodies may be used. Additionally, it is also quite possible for a contact body to be used in the form of a rod, using at the same time the wall of the vessel as a contact body.

In order to observe the movement of the filter material at that location by using such a rod positioned in any random location in the filter bed, it is advantageous, according to the invention, if the rod extends through a casing pipe running parallel to the rod, enclosing the rod at a distance and extending into the filter bed, whereby the one end of the rod extends from the casing pipe and lies in the filter bed, and whereby the vibration sensor is provided at the other end of the rod. The casing pipe protects the rod for a substantial portion of its length from the filter material so that only the end of the rod, at a specifically determined location, comes into contact in the filter bed with the filter bed material and is thus subjected to vibrations. In this case, it is highly advantageous when the casing pipe does not conduct the vibrations sensed by the sensor as well as the rod. In this connection, it is advantageous when the rod is made of a metal and the casing pipe is made of a plastic, such as polypropylene.

To observe the movement of the granular filter material, according to the invention, it is particularly advantageous if the vibration sensor is sensitive to vibrations with a frequency of at least 50 kHz. The vibrations produced by the granular material, particularly sand, when it comes in contact with the contact body, appear in particular to be of a high frequency. In this connection, it is a further advantage if the vibration sensor is sensitive to vibrations within the range of 50 kHz to 300 kHz. In order for vibrations from other sources and thus interference or noise in the signal emitted by the vibration sensor to be disregarded, it is advantageous, according to the invention, if the sensor system comprises a filter that blocks vibrations with a frequency of less than approximately 50 kHz. Additionally, the sensor system may also comprise a filter to filter out vibrations with a frequency higher than 300 kHz.

According to a further embodiment, it is advantageous if the transport system comprises a lift pipe with its lower end extending into the filter bed and with its upper end extending above the filter bed. Such lift pipes are known [in the prior art]. In such cases, a gas is usually blown into the lower end of the lift pipe so that a gas lift is created in the lift pipe. To this end, a gas supply is usually provided at the lower end of the lift pipe. As known in the prior art, a gas lift may occur here in which a second pipe, known as an outer pipe, is disposed around the lift pipe, with a space between the outer pipe and the lift pipe, wherein a fluid, in particular, can be fed downwards in order to facilitate the movement of filter material moving upwards in the lift pipe from the bottom of the lift pipe.

According to a further embodiment of the invention, the vessel has a zone at the bottom with a converging bottom section, and the bottom of the lift pipe is disposed in that zone with the converging bottom section. This converging bottom section contributes to the transport of filter material to the bottom of the vessel transported upwards through the lift pipe.

According to the invention, the vibration sensor is connected in an advantageous manner to a processing device. Such a processing device may for example be a display device such as a monitor or loudspeaker for generating the signal produced by the sensor. Such a processing device may also be a computer for storing the signal or for actuating the device based upon the signal.

The invention relates further to a method for determining the degree of movement of a filter bed with granular filter material, wherein a contact body is used which comes into contact with the filter material in the filter bed, and wherein the degree of movement of the filter material is determined by sensing the vibrations caused by the movement of the granular filter material of that contact body. Advantages of the method according to the invention will become apparent from the foregoing description of the device according to the invention.

The present invention will be described below in more detail with reference to the example shown in the figure.

The numeral 1 in the figure indicates a vessel with a bed 2 of filter material therein, in this case sand and/or quartzite sand and/or granite sand. The vessel 1 is formed from a cylindrical section with a conical section at the bottom. The top of the vessel is open, but this may also be closed.

In the centre of the vessel 1 there is a transport system, arranged for agitating the filter material of the filter bed when in operation. The transport system here is arranged as a gas lift. Although the gas lift may comprise a single lift pipe 26, in this case a second pipe 3, called an outer pipe, is disposed around the pipe lift 26. This outer pipe 3 extends to the lower end 27 of the lift pipe 26, but ends in particular at some distance above that lower end 27. A gas feed nozzle 28 is provided beneath the lower end 27, through which gas is supplied. The gas enters the lift pipe 26, as a result of which the density of the fluid in the lift pipe 26 decreases and is driven upwards. Fluid is fed via space 39 between the pipe lift 26 and the outer pipe 3 to the lower end 27 of the lift pipe. This facilitates causing a fluidized state of the granular filter material at the lower end of the lift pipe 26, thus making it easier for filter material to be forced upwards.

About halfway the height of the vessel, another jacket 4 is disposed around the lift pipe 26 and the pipe 3, which is connected to a feeding tube 5 for the fluid to be cleaned (also known as influent), which is added at 6. At the lower side of the jacket 4, a multiple of distribution channels 7 is provided, which may be arranged, for example, in the shape of a star, and a U-shaped cross section, which is open in a downward direction. The fluid to be cleaned, influent, can be distributed in the filter bed via these distribution channels 7.

A conical jacket 8 is further provided beneath the distribution channels 7. This serves for channeling the sand (or other filter material), so that a homogeneous circulation of the sand (or other filter material) is achieved.

A further jacket 9 is provided around the portion of the lift pipe 26 and casing pipe 3 extending above the bed 2 of filter material. The inside of the jacket 9 and the outside of the outer side of the outer pipe 3, are alternately provided with ribs with a downward sloping surface on the upper side. These ribs enable the filter material forced up by the lift pipe 26 via the space 29 between the jacket 9 and the outer pipe 3 to descend, while fluid is allowed to flow upwards via the same interstitial space 29. The lift pipe 3 leads to a tank 10 with a discharge pipe 11 leading out, the inlet end 30 of which acts as an overflow for the fluid contained in the vessel 1. Thus, silt and other debris can be discharged from the discharge pipe 11.

Cleaned fluid can flow over overflow edge 31 into the discharge 12 in order to be discharged from the vessel 1.

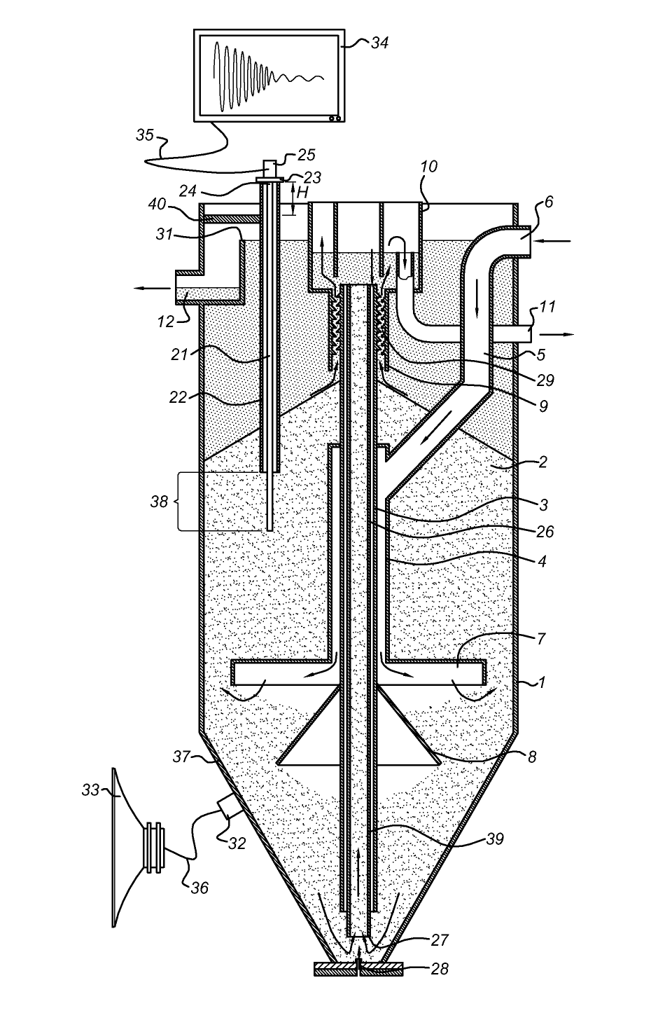

According to the invention, the device depicted in FIG. 1 is equipped with two sensors. These two sensors can be either jointly applied or entirely separate from each other.

The first sensor system comprises the wall 37 of the vessel 1 as a contact body and a vibration sensor 32 disposed against the wall 37 in order to sense the vibrations caused by the granular particles of the filter material moving along the inside of the wall 37. This sensor 32 provides a signal that depends on the vibrations detected by the sensor. This signal is transmitted via a signal line 36 to a signal generating device, such as a loudspeaker 33 that produces an audible signal. It will be apparent that the audible signal may be a processed signal (such as a filtered signal) of the observed signal.

The second sensor system comprises a rod 21 extending into the filter bed 2 and is enclosed by a casing pipe 22. The rod 21 is specifically of metal and the sleeve tube 22, is specifically of polypropylene or HDPE. The casing pipe 22 shields the rod 21 along a portion of the length so that only the lower end 38 of the rod 21 extending from the casing pipe 22 acts as an effective contact body. This bottom section 38 can, for example, be between 10 to 50 cm, such as 30 cm in length. The casing pipe 22 is suspended on an arm 40, in this case, to the wall of the vessel 1. The rod 21 is attached to a plate 23, for example by means of a weld connection 24. A vibration sensor 25 is provided on the upper side of the plate 23. This vibration sensor produces a signal which is dependent on the vibrations detected by the sensor.

In particular, the synthetic casing pipe 22 does not conduct vibrations as well as the rod 21 itself. The casing pipe 22 shields the rod 21 along a large portion of the length from the environment, in particular from the sand or other filter material, in order to prevent the rod 21 being subjected to ambient vibrations. This therefore minimizes interferences. By providing the attachment of the arm 40 to the plastic casing pipe at a distance of at least 10 cm, for example at about 15 cm, vibrations transferred from the environment through the arm to the casing pipe are prevented or almost entirely prevented from reaching the plate 23 and vibration sensor 25. The plastic casing pipe therefore acts as a vibration insulator.

The signal produced by the vibration sensor is fed via a signal line 35 to a signal processing device such as a display device, for example, a monitor 34. The operator can then visually observe a signal on the monitor 34 that represents motion or flow of the filter bed material. If a flow change occurs, it is shown on the monitor, as is illustrated schematically in the monitor 34. The operator can then take action in order to restore the desired state in the vessel again.

It will be clear that loudspeaker 33 may also be a monitor 34 and that, conversely, the monitor 34 may also be a loudspeaker 33. A display device other than a loudspeaker or monitor, such as lamps, LEDs, a warning light or a printer, is also possible according to the invention. It will be apparent that the signal lines 35 and 36 may also lead to a control computer which further controls the device in a fully automated manner.

The vibration sensor used is particularly sensitive to a high-frequency sound spectrum lying within the range of about 50 kHz to 300 kHz. It is within this range of vibrations that the moving granular materials such as sand, rub along the rod 21 and/or along the wall 37 of the vessel 1 which produce acoustic sound waves. By applying special filters to those vibrations below 50 kHz and/or by filtering out (prevent them from passing through) vibrations in excess of 300 kHz, it is possible to make the measurements insensitive to interference by other sounds. Such a filter may be an electronic filter, but may also be integrated in the sensor, for instance, because the type of sensor used is only sensitive to vibrations within a certain frequency range. In the case of the second sensor system in particular, the casing pipe ensures an acoustic insulation between the rest of the structure and the metal plate 23/sensor 25.

1. Device for cleaning a fluid, wherein the device comprises:
a vessel;
a filter bed with granular filter material, such as sand, wherein the filter bed is provided within the vessel;
a transport system arranged to cause movement of filter material of the filter bed during operation;
a sensor system;
characterized in that the sensor system comprises:
a contact body (21, 37) that comes in contact with the filter material in the filter bed (2);
a vibration sensor (25, 32) connected to the contact body (21, 37) for sensing vibrations of said contact body (21, 37);
wherein the vibration sensor (25, 32) is arranged for producing a signal that is dependent on the vibrations detected by the sensor.

2. Device according to claim 1, wherein the contact body comprises the wall (37) of the vessel (1).

3. Device according to claim 1, wherein the contact body comprises a rod (21) extending into the filter bed (2).

4. Device according to claim 3, wherein the rod (21) extends through a casing pipe (22) running parallel to the rod (21), that encloses the rod (21) at a distance and which extends into the filter bed (2), wherein the one end (38) of the rod protrudes from the casing pipe and is disposed in the filter bed, and wherein the vibration sensor (25) is provided at the other end of the rod.

5. Device according to claim 4, wherein the casing pipe (22) does not conduct vibrations detected by the sensor (25) as well as the rod (21).

6. Device according to claim 5, wherein the rod (21) is made of metal and the casing pipe (22) is made of a plastic, such as polypropylene.

7. Device according to claim 1, wherein the vibration sensor (25, 35) is sensitive to vibrations with a frequency of at least 50 kHz.

8. Device according to claim 7, wherein the vibration sensor (25, 35) is sensitive to vibrations within the range of 50 kHz to 300 kHz.

9. Device according to claim 7, wherein the sensor system comprises a filter that prevents vibrations with a frequency lower than approximately 50 kHz.

10. Device according to claim 1, wherein the transport system comprises a lift pipe (26), the lower end (27) of which lies in the filter bed (2) and the upper end of which lies above the filter bed (2).

11. Device according to claim 10, wherein the vessel (1) has a zone at the bottom with a converging bottom section and wherein the lower end (27) of the lift pipe (26) lies within that zone together with the converging bottom section.

12. Device according to claim 10, wherein the transport system comprises a gas lift, the lift pipe (26) member forming a part thereof.

13. Device according to any of the preceding claims, wherein the vibration sensor (25 35) is connected to a processing device such as a monitor (34) or loudspeaker (33) for generating the signal produced by the sensor, or such as computer for storing the signal or the actuation of the device based on said signal.

14. Method for determining the degree of movement of a filter bed (2) with granular filter material, wherein a contact body (21, 37) is used which comes into contact with the filter material in the filter bed (2), and wherein the degree of movement of the filter material is determined by sensing the vibrations caused by the movement of the granular filter material of that contact body (21, 37).

15. Method according to claim 14, wherein vibrations with a frequency greater than 50 kHz are detected.

16. Method according to claim 14, wherein vibrations with a frequency lower than 50 kHz are ignored, for example filtered out.
